(19) United States
(12) Patent Application Publication
(10) Pub. No.: US 2007/0137903 A1
(43) Pub. Date: Jun. 21, 2007

(54) Vehicle with an under-carriage provided with crawler belts

(75) Inventor: Michael Falck Schmidt, Kerteminde (DK)

Correspondence Address: JAMES C. WRAY, 1493 CHAIN BRIDGE ROAD, SUITE 300, MCLEAN, VA, 22101, US

(73) Assignee: E.FALCK SCHMIDT A/S, Odense C, (DK)

(21) Appl. No.: 10/581,956

(22) PCT Filed: Dec. 9, 2004
(86) PCT No.: PCT/DK04/00850

§ 371 Date: Dec. 6, 2006

(30) Foreign Application Priority Data
Dec. 11, 2003 (DK) 2003 01834

(51) Int. Cl. B62D 55/104

(52) U.S. Cl. 180/9.46; 305/120; 180/9.52; 305/44

(57) ABSTRACT

One a vehicle with an under-carriage (1) provided with crawler belts that by the foremost and hindmost end has a protruding part, the belts (2) are split into a foremost section, that is, placed under the foremost protruding part, and a hindmost section, that is placed under the hindmost protruding part. Hereby, the total height can be reduced without the total width that is determined by the belts is increased. It can hereby be advantageous that at least one of the belt units is suspended vertically movable, e.g. about a horizontal axis pivotable tilting joint (5). Hereby, the under-carriage can be lifted free when passing over the top of a hill.

The present invention relates to a vehicle with an under-carriage provided with crawler belts that at the foremost og hindmost end has a protruding part, and where the belts are split into a foremost section, that is placed under the foremost protruding part, and a hindmost section that is placed under the hindmost protruding part.

Such under-carriages that are provided with crawler belts are being used for many purposes and has the advantage over under-carriages that are equipped with wheels, that crawler belts exerts a relatively lower surface pressure on the support. Under-carriages provided with crawler belts are therefore widely used on vehicles/mobile units that are performing in terrain, including terrain with soft subsoil and terrain with large changes in rise.

Usually, under-carriages are provided with a right and a left belt. To achieve a narrow construction, the two belts can be placed under the under-carriage. This will however lead to the fact that the total height of the construction becomes at least the sum of the height of the under-carriage and the height of the belts. It is thus advantageous that the belts are split into a foremost section that is placed under the foremost protruding part, and a hindmost section that is placed under the hindmost protruding part. In this manner the under-carriage itself can be lowered down between the belt sections in such a manner that the total height of the construction are decided by the height of the belts plus (only) the height of the protruding parts.

According to the invention, it is advantageous that at least one of the belt units are suspended in a manner where it is vertically moveable, e.g. in a about a horizontal axis pivotable tilting joint. In this manner, the under-carriage can be lifted free when passing the top of a hill.

The invention will in the following be explained further with relation to the drawing, where:

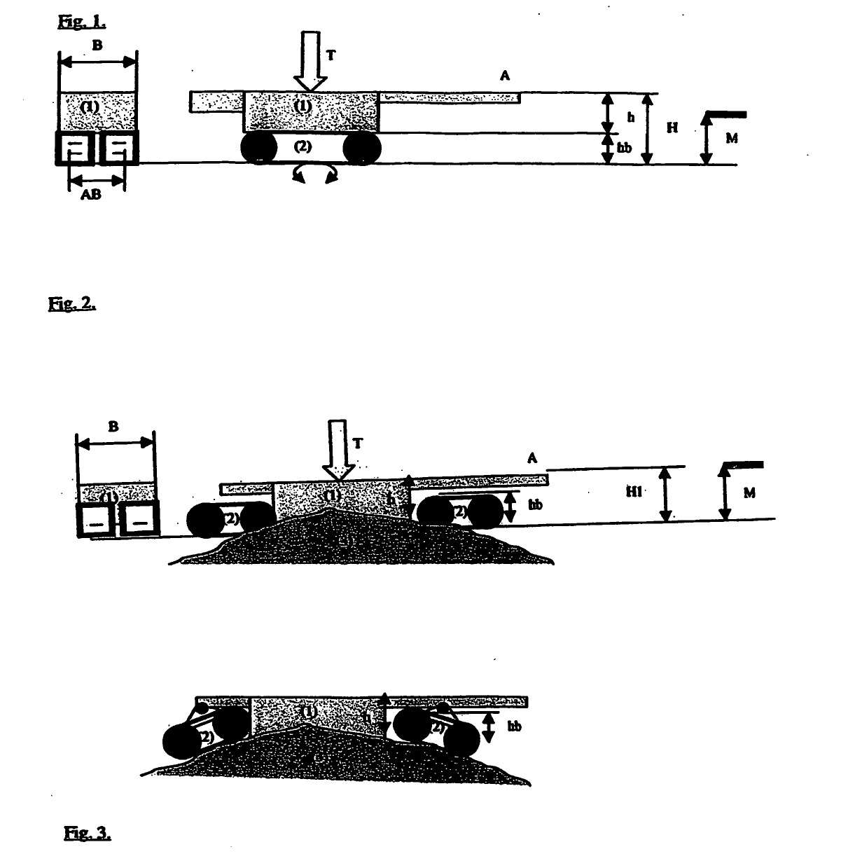

FIG. 1 shows a known construction of a under-carriage; and

FIG. 2-5 different embodiments for the construction of a under-carriage according to the present invention.

FIG. 1 shows a known embodiment for the undercarriage of a vehicle equipped with crawler belts. The undercarriage has, by its foremost and hindmost end, a protruding part. The length of the belts 2 is adapted to the line of gravity of the under-carriage 1, that even when driving on the highest possible pitch, must be within the carry-length of the belts.

The width of the belts 2 is limiting how slim the construction can be built. To make the total width B as small as possible, the belts are placed under the under-carriage.

This implies that the total height H of the construction is at least equal to the sum of the height h of the the under-carriage 1 and the height hb of the belts 2. The vehicle can not pass a height M that is less than H.

Another problem with the shown, known construction is the necessary tractive force when the vehicle is turning by changing the relative velocity of the two belts. This tractive force grows inversely proportional to the distance AB between the two belts. When the belts are very close—which is the case when the width B is to be minimised—the necessary tractive force is very big.

The problem of height is solved by the construction shown in FIG. 2 where the belts are split into a foremost section that is placed under the foremost protruding part, and a hindmost section that is placed under the hindmost protruding part, while the under-carriage 1 is lowered down between the belt sections. In this case, the total height H1 of the construction is determined by only the height of the protruding part plus the height of the belts hb.

As seen in FIG. 2, the shown construction is able to move in flat terrain. When having to pass e.g. the top of a hill 3, two problems arise. The under-carriage 1 impacts with the surface because of the low construction. And the belts does not assume a plane position on the surface which will make the surface pressure on the underground considerable. Parts of the belts will be “floating” in air.

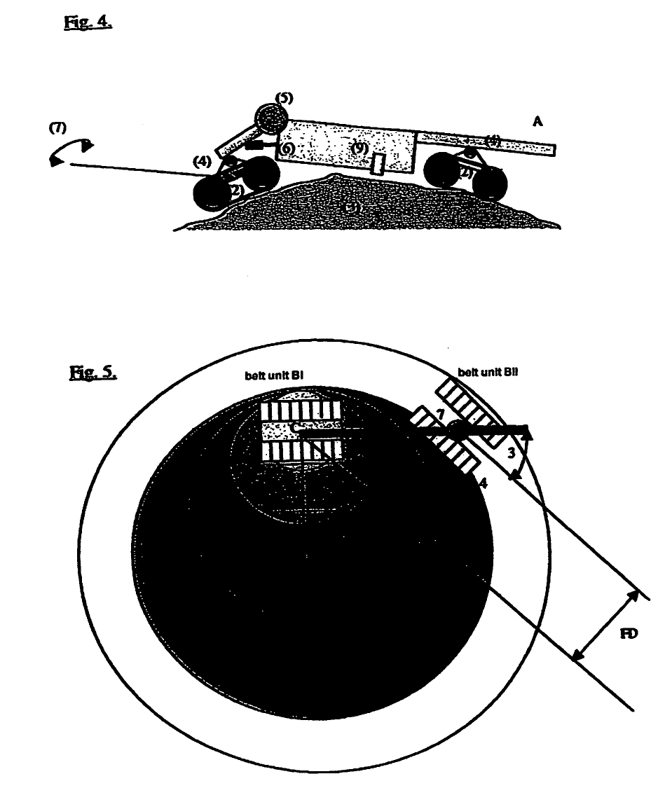

This last problem is solved in that each belt section is suspended in a about a horizontal axis pivotable joint in such a manner that each section adjusts to the terrain as it is shown in FIG. 3.

The problem related to the passage of the lowered under-carriage over the top of the hill can according to the invention be solved by having at least one of the belt units suspended in a vertically moveable, e.g. in a about a horizontal axis pivotable tilting joint as shown in FIG. 4. This tilting joint assure that the under-carriage can be lifted free of the underground. The control of the tilting joint is achieved e.g. by means of a cylinder 6.

1. Vehicle with an under-carriage (1) provided with crawler belts that by the foremost and hindmost end has a protruding part, and where the belts (2) are split into a foremost section that is placed under the foremost protruding part, and a hindmost section that is placed under the hindmost protruding part, characterized in that at least one of the belt units is suspended vertically moveable, e.g. in a about a horizontal axis pivotable tilting joint (5).
